(19) United States
(12) Patent Application Publication
(10) Pub. No.: US 2025/0342014 A1
(43) Pub. Date: Nov. 6, 2025

(54) SOFTWARE DEVELOPMENT VISUALIZATION

(71) Applicant: TOYOTA JIDOSHA KABUSHIKI KAISHA, Aichi-ken (JP)

(72) Inventors: Sebastian STAPELFELDT, Tokyo-to (JP); Oszkar JOZSA, Tokyo-to (JP); Steven LIM, Tokyo-to (JP); Thomas HAUTH, Tokyo-to (JP); Young BAE, Tokyo-to (JP)

(21) Appl. No.: 18/651,697

(22) Filed: May 1, 2024

(51) Int. Cl. G06F 8/34; G06F 8/41

(52) U.S. Cl. CPC G06F 8/34; G06F 8/433

(57) ABSTRACT

Software development visualization is performed by reading a configuration file of a plurality of software parts in response to building the plurality of software parts, the plurality of software parts including a first software part and a second software part, the second software part depending upon the first software part, and generating a record of the plurality of software parts, the record including dependency between the first software part and the second software part, a build status of the plurality of software parts, and an integration status between the first software part and the second software part.

### BACKGROUND

Some products, such as those that have many sensors and motors, implement functionality via general computational components between them running specialized software. Software for such products may not exist as a single program, but a web of interdependent software parts, such as programs, libraries, platforms, etc.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a schematic diagram of a system for software development visualization, according to at least some embodiments of the subject disclosure.

FIG. 2 is an operational flow for software development visualization, according to at least some embodiments of the subject disclosure.

FIG. 3 is an operational flow for building software parts, according to at least some embodiments of the subject disclosure.

FIG. 4 is an operational flow for displaying a visual representation, according to at least some embodiments of the subject disclosure.

FIG. 5 is a visual representation in a table format, according to at least some embodiments of the subject disclosure.

FIG. 6 is a visual representation in a node format, according to at least some embodiments of the subject disclosure.

FIG. 7 is a visual representation in a network format, according to at least some embodiments of the subject disclosure.

FIG. 8 is a block diagram of a hardware configuration for software development visualization, according to at least some embodiments of the subject disclosure.

### DETAILED DESCRIPTION

The following disclosure provides many different embodiments, or examples, for implementing different features of the provided subject matter. Specific examples of components, values, operations, materials, arrangements, or the like, are described below to simplify the present disclosure. These are, of course, merely examples and are not intended to be limiting. Other components, values, operations, materials, arrangements, or the like, are contemplated. In addition, the present disclosure may repeat reference numerals and/or letters in the various examples. This repetition is for the purpose of simplicity and clarity and does not in itself dictate a relationship between the various embodiments and/or configurations discussed.

As products with software-implemented functionality are developed, software parts are modified, which impacts other software parts, such as those that are dependent on the modified software part. For individuals developing a software part, awareness of the development of its dependencies is beneficial. Records of such development may be distributed across multiple repositories, each with different access. As a product increases in complexity, the number of repositories may also increase. A new dependency, such as a dependency of a library used by a functional component of a given developer's software part, may not be known to the developer unless and until the repository of the dependency is accessed. Access to all repositories in a dependency chain gives developers certainty in their awareness of dependencies.

In systems known to the inventors, a variety of attributes of each software part are determined. However, in the event of software part build failure, developers encounter difficulties in determining which software part was the immediate cause of the failure.

In at least some embodiments, development records of software parts for a product are collected and assembled into a database. In at least some embodiments, dependency information of each software part is used to generate views of the software web. In at least some embodiments, the status of a given software part is shown between software parts that depend upon and software parts that are depended upon by the given software part. In at least some embodiments, all software parts are mapped onto a graph that shows dependency relationships as connections between software parts.

In at least some embodiments, a record of a build of software parts is recorded to a database in response to building the software parts. In at least some embodiments, the record indicates build status, dependency among software parts, and integration status. In at least some embodiments, a visual representation of the record viewable by a client device visually indicates the dependency between a first software part and a second software part, the build status of the second software part, and the integration status of the first software part with respect to the second software part.

In at least some embodiments, assembling software part information into one database relieves the burden of checking each and every repository for such information. In at least some embodiments, the database stores historical information, a snapshot of the status of a given point in time is accessible. In at least some embodiments, information about the input software parts, or dependencies, of each software part, is collected to ascertain relationships among projects and the software parts thereof. In at least some embodiments, the network and node views are generated from the ascertained relationships, such as which libraries and other software parts are utilized by each project. In at least some embodiments, the network view improves the node view by showing software parts that have no dependencies, which can be referred to as “leaves”. In at least some embodiments, software parts that have no dependencies do not show up in node view unless by a specific search.

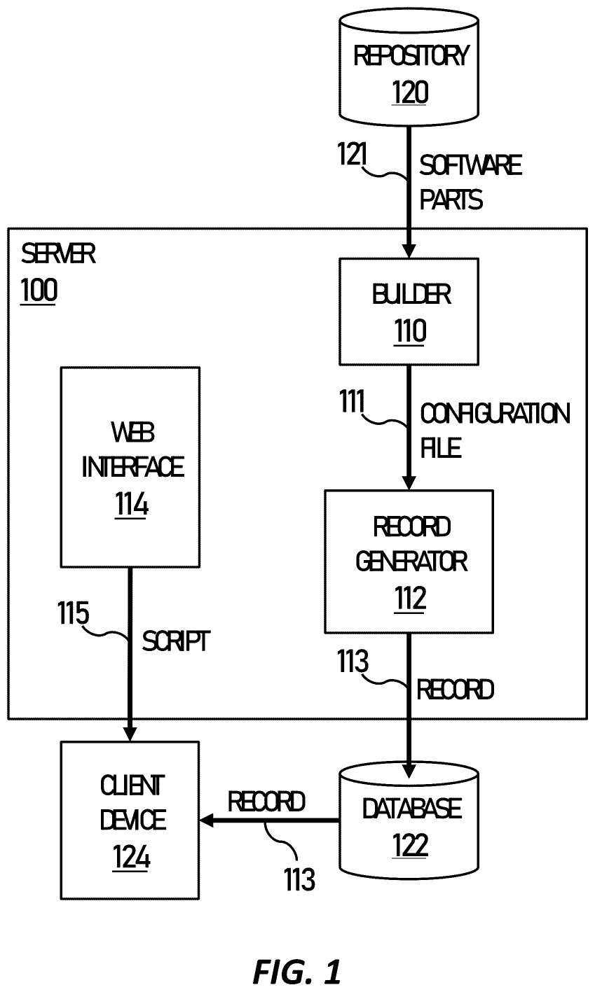

FIG. 1 is a schematic diagram of a system for software development visualization, according to at least some embodiments of the subject disclosure. The system includes a server 100, a repository 120, a database 122, and a client device 124.

Server 100 is in communication with repository 120, database 122, and client device 124. Server 100 includes builder 110, record generator 112, and web interface 114. In at least some embodiments, server 100 is involved in software development visualization. In at least some embodiments, server 100 is configured to host builder 110, record generator 112, and web interface 114. In at least some embodiments, server 100 communicates with the database to store a build record. In at least some embodiments, server 100 retrieves the build record upon request. In at least some embodiments, server 100 interacts with the client device to serve the web interface. In at least some embodiments, server 100 handles user requests. In at least some embodiments, server 100 is a physical server in a data center. In at least some embodiments, server 100 is a virtual server in a cloud environment. In at least some embodiments, server 100 runs an operating system like Linux or Windows Server. In at least some embodiments, server 100 runs server software, such as APACHE, NGINX, NODE.JS, etc. In at least some embodiments, server 100 includes an operating system, the server software, and the applications. In at least some embodiments, the applications include builder 110, record generator 112, and web interface 114. In at least some embodiments, server 100 includes a firewall for security. In at least some embodiments, server 100 includes a load balancer for handling traffic. In at least some embodiments, server 100 includes a database management system for interacting with database 122.

Builder 110 is in communication with repository 120 and record generator 112. In at least some embodiments, builder 110 is configured to receive software parts 121 from repository 120. In at least some embodiments, builder 110 is configured to read configuration file 111, build software parts 121, and run tests. In at least some embodiments, builder 110 is configured to transmit configuration file 111 to record generator 112 after building software parts 121. In at least some embodiments, builder 110 is configured to perform version control. In at least some embodiments, builder 110 is includes build tools, such as MAVEN, GRADLE, NPM, etc. In at least some embodiments, builder 110 is configured to automate the build and test process. In at least some embodiments, builder 110 is configured to update the build status of software parts 121 with the newest or previous release tag based on the build success.

In at least some embodiments, configuration file 111 is configured to store details of software parts 121, including dependencies and tests to be performed. In at least some embodiments, configuration file 111 includes information for builder 110 to understand the build and test process. In at least some embodiments, configuration file 111 is a JSON file, an XML file, etc. In at least some embodiments, configuration file 111 includes fields for software part names, dependencies, versions, and tests. In at least some embodiments, configuration file 111 indicates the version of each input software part used during the building.

Record generator 112 is in communication with builder 110 and database 122. In at least some embodiments, record generator 112 is configured to generate record 113 of the build of software parts 121, including dependencies, build status, and integration status. In at least some embodiments, record generator 112 is configured for parsing configuration file 111 and generating record 113. In at least some embodiments, record generator 112 is configured to track the status of builds in continuous integration systems. In at least some embodiments, record generator 112 is configured to include the time of building the software parts in record 113.

In at least some embodiments, record 113 is configured to store the details of the build, including dependencies, build status, and integration status. In at least some embodiments, record 113 is a row in a database table, a document in a NoSQL database, etc. In at least some embodiments, record 113 contains fields for software part names, dependencies, build status, integration status, and build time. In at least some embodiments, record 113 includes the integration status between a given software part and a dependent software part.

Web interface 114 is in communication with client device 124. In at least some embodiments, web interface 114 is configured to enable users to request and view record 113. In at least some embodiments, web interface 114 hosts script 115, which enables client device 124 to submit requests to database 122, receive record 113, and display the information in record 113 for a user. In at least some embodiments, web interface 114 is a web application built with HTML, CSS, JavaScript, etc. In at least some embodiments, web interface 114 includes pages or views for requesting viewing record 113.

In at least some embodiments, script 115 is configured to provide instructions for displaying a visual representation of record 113. In at least some embodiments, script 115 is executed by a web browser of client device 124. In at least some embodiments, script 115 is an HTML file, a JavaScript file, etc. In at least some embodiments, script 115 comprises instructions of functions or methods for creating the visual representation and handling user interactions. In at least some embodiments, script 115 is configured with web page interactivity. In at least some embodiments, script 115 is in HTML and includes instructions for switching a visual representation in response to interaction with a given software part and sorting software parts by dependency.

Repository 120 is in communication with builder 110. In at least some embodiments, repository 120 is configured to store software parts 121. In at least some embodiments, repository 120 is accessed by builder 110 to retrieve software parts 121 for building. In at least some embodiments, repository 120 is a GIT repository or a MAVEN repository. In at least some embodiments, repository 120 contains a version history of software parts 121. In at least some embodiments, repository 120 is configured for software development, version control, and dependency management. In at least some embodiments, repository 120 stores a plurality of software parts including software parts 121.

In at least some embodiments, software parts 121 are individual components that are built and tested by builder 110. In at least some embodiments, software parts 121 are stored in repository 120 and read by builder 110. In at least some embodiments, software parts 121 include libraries, modules, services, etc., in a software project. In at least some embodiments, each software part contains a set of files and directories. In at least some embodiments, software parts 121 are useful in software development to modularize code and manage complexity.

In at least some embodiments, database 122 is configured to store record 113 of the build, which includes dependencies, build status, and integration status. In at least some embodiments, database 122 interacts with record generator 112. In at least some embodiments, database 122 receives record 113 from builder 110 and serves record 113 to client device 124 upon request. In at least some embodiments, database 122 includes MySQL, PostgreSQL, MongoDB, etc. In at least some embodiments, database 122 comprises tables or collections to store the build records, such as record 113. In at least some embodiments, database 122 is configured for persistent data storage.

Client device 124 is in communication with web interface 114 and database 122. In at least some embodiments, client device 124 is configured to execute script 115 to request and display record 113. In at least some embodiments, client device 124 sends requests to database 122 and receives record 113. In at least some embodiments, client device 124 executes script 115 to display a visual representation. In at least some embodiments, client device 124 is a personal computer, a smartphone, a tablet, etc. In at least some embodiments, client device 124 comprises a web browser to execute script 115 and display the visual representation. In at least some embodiments, client device 124 is used to interact with various web applications. In at least some embodiments, client device 124 is configured to enable user interaction to switch the mode of visual representation and sort the software parts by dependency.

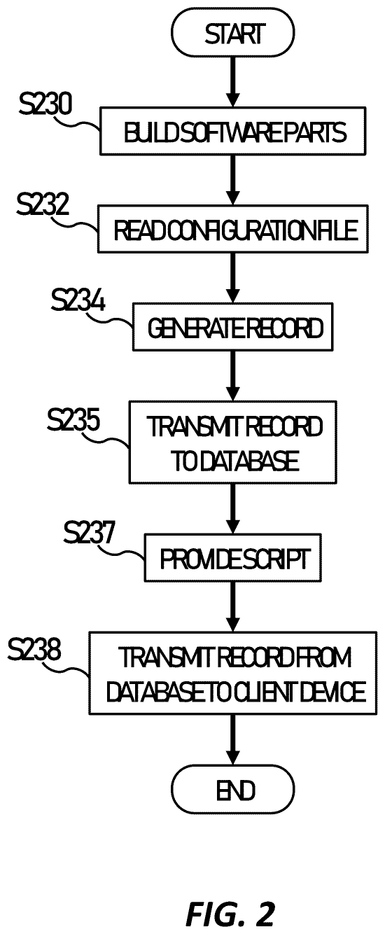

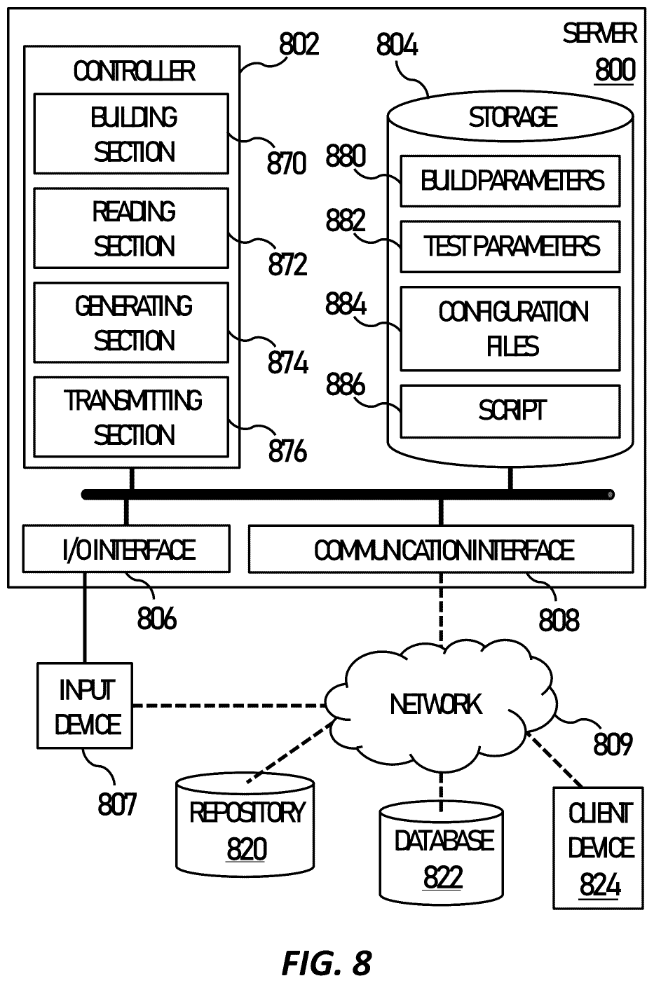

FIG. 2 is an operational flow for software development visualization, according to at least some embodiments of the subject disclosure. In at least some embodiments, the operational flow provides a method of software development visualization, according to at least some embodiments of the subject disclosure. In at least some embodiments, the method is performed by a controller of a server, such as controller 802 of server 800 of FIG. 8, described hereinafter.

At S230, the controller builds software parts. In at least some embodiments, the controller compiles and links the software parts to create an executable or library. In at least some embodiments, the controller builds the plurality of software parts, wherein the build status indicates a newest release tag in response to successfully building the plurality of software parts, and wherein the build status indicates a previous release tag in response to not successfully building the plurality of software parts. In at least some embodiments, the controller fetches dependencies, compiles source code, links libraries, and packages the software build into a distributable format. In at least some embodiments, the controller triggers automated tests to verify correctness of the build. In at least some embodiments, the controller verifies whether the source code of the software parts is available and in a buildable state. In at least some embodiments, the controller resolves dependencies. In at least some embodiments, the controller sets up the build environment, such as the compiler and build scripts. In at least some embodiments, the controller creates a working version of the software build for testing and deployment.

At S232, the controller reads a configuration file. In at least some embodiments, the controller reads a configuration file associated with the software parts. In at least some embodiments, the controller reads a configuration file of a plurality of software parts in response to building the plurality of software parts, the plurality of software parts including a first software part and a second software part, the second software part depending upon the first software part. In at least some embodiments, the controller parses the configuration file. In at least some embodiments, the controller handles any errors or inconsistencies in the configuration file. In at least some embodiments, the controller obtains information about the software parts, including dependencies and versions of each input software part used during the building.

At S234, the controller generates a record. In at least some embodiments, the controller generates a record that includes the dependency between the software parts, their build status, and their integration status. In at least some embodiments, the controller generates a record of the plurality of software parts, the record including dependency between the first software part and the second software part, a build status of the plurality of software parts, and an integration status between the first software part and the second software part. In at least some embodiments, the controller creates a data structure to hold the record and serialize the data structure into a format suitable for transmission to a database, such as an SQL insert statement or a JSON object.

At S235, the controller transmits the record to a database. In at least some embodiments, the controller transmits the record to a database for storage. In at least some embodiments, the controller transmits the record to a database. In at least some embodiments, the controller establishes a connection to the database, handles any connection errors, and ensures successful transmission of the record.

At S237, the controller provides a script. In at least some embodiments, the controller provides a script for displaying a visual representation of the interdependency among the software parts. In at least some embodiments, the controller provides, to a client device, a script including instructions for displaying a visual representation of interdependency among the plurality of software parts. In at least some embodiments, the controller provides a script to a client device. In at least some embodiments, the controller generates the script dynamically based on the current state of the client device.

At S238, the controller transmits the record from the database to the client device. In at least some embodiments, the controller retrieves the record from the database and sends it to a client device in response to a request. In at least some embodiments, the controller queries the database to retrieve the record, handles any query errors, and transmits the record over a network connection to the client device. In at least some embodiments, the controller establishes a direct connection between the client device and the database.

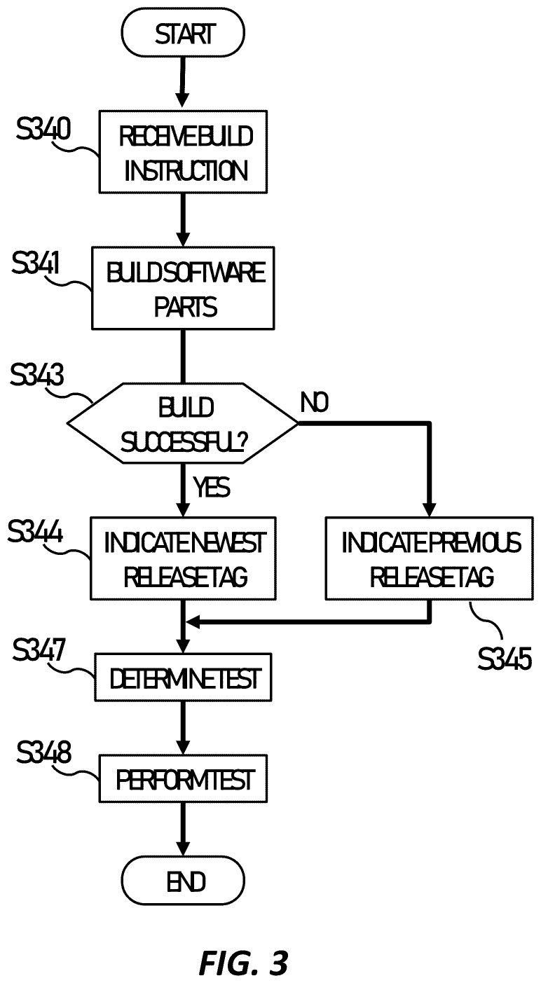

FIG. 3 is an operational flow for building software parts, according to at least some embodiments of the subject disclosure. In at least some embodiments, the operational flow provides a method of building software parts, according to at least some embodiments of the subject disclosure. In at least some embodiments, the method is performed by a controller of a server, such as controller 802 of server 800 of FIG. 8, described hereinafter.

At S340, the controller receives a build instruction. In at least some embodiments, the controller receives an instruction to build software parts. In at least some embodiments, the controller initiates the build process in response to receiving the build instruction.

At S341, the controller builds software parts. In at least some embodiments, the controller reads the configuration file. In at least some embodiments, the controller identifies the dependencies. In at least some embodiments, the controller builds the software parts in a designated order. In at least some embodiments, the controller builds the software parts as per the dependencies and instructions in the configuration file.

At S343, the controller determines whether the build process was successful. In at least some embodiments, the controller updates the build status based on the success or failure of the build process. In at least some embodiments, in response to a successful build, the operational flow proceeds to new release tag indication at S344. In at least some embodiments, in response to an unsuccessful build, the operational flow proceeds to previous release tag indication at S345.

At S344, the controller indicates a newest release tag. In at least some embodiments, in response to a successful build, the controller updates the build status to indicate the newest release tag. In at least some embodiments, the newest release tag indicates that the latest build is successful.

At S345, the controller indicates a previous release tag. In at least some embodiments, in response to an unsuccessful build, the controller updates the build status to indicate the previous release tag. In at least some embodiments, the controller sends an error report or notification about the failed build.

At S347, the controller determines a test. In at least some embodiments, the controller reads the configuration file to determine the tests to be performed.

At S348, the controller performs the test. In at least some embodiments, the controller performs the tests identified at S347. In at least some embodiments, the controller updates the integration status based on the test results. In at least some embodiments, the controller produces the test results. In at least some embodiments, the controller indicates the integration status as indicated as success, failure, or not running. In at least some embodiments, the functionality and compatibility of the built software parts are validated.

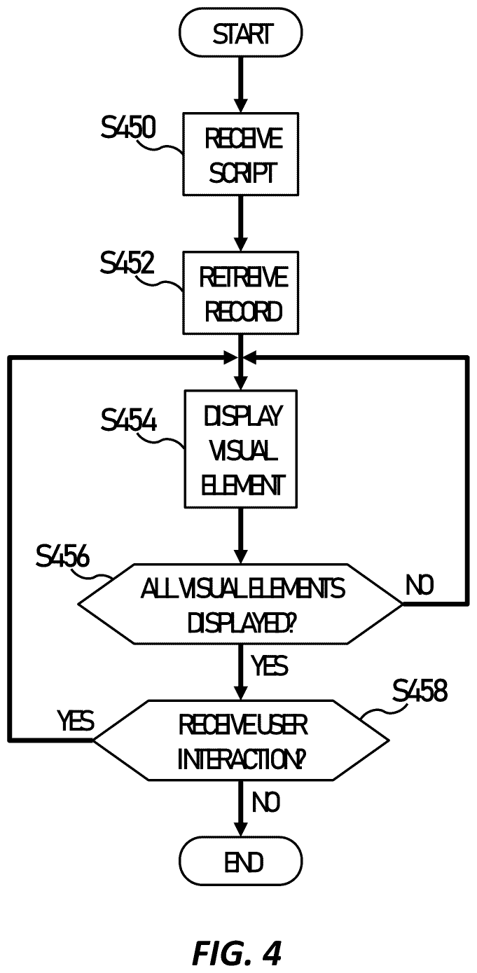

FIG. 4 is an operational flow for displaying a visual representation, according to at least some embodiments of the subject disclosure. In at least some embodiments, the operational flow provides a method of displaying a visual representation, according to at least some embodiments of the subject disclosure. In at least some embodiments, the method is performed by a client device, such as client device 824 of FIG. 8, described hereinafter.

At S450, the client device receives the script. In at least some embodiments, the client device receives the script from the server. In at least some embodiments, the client device establishes a connection with the server. In at least some embodiments, the client device sends a request for the script. In at least some embodiments, the server processes the request. In at least some embodiments, the server sends the script to the client device. In at least some embodiments, the script contains instructions for the visual representation of the software parts.

At S452, the client device retrieves the record. In at least some embodiments, the client device sends a request to the database to retrieve the record of the software parts. In at least some embodiments, the database processes this request. In at least some embodiments, the database returns the record. In at least some embodiments, the client device receives the record.

At S454, the client device displays a visual element. In at least some embodiments, the client device interprets the script. In at least some embodiments, the client device generates a visual element of the software parts based on the record. In at least some embodiments, the client device renders the visual element on a display. In at least some embodiments, the client device is capable of rendering the visual element. In at least some embodiments, the visual element is one of a software part, a dependency, a build status, an integration status, etc.

At S456, the client device determines whether all visual elements have been displayed. In at least some embodiments, the client device checks if all elements in the visual representation have been rendered. In response to determining that all visual elements have been displayed, the operational flow proceeds to user interaction reception determination at S456. In response to determining that all visual elements have not been displayed, the operational flow returns to visual element display at S454.

At S458, the client device determines whether there is user interaction with the visual representation. In at least some embodiments, the user interaction is a click on a software part. In at least some embodiments, the user interaction is a request to sort the software parts by dependency. In at least some embodiments, the client device processes the user interaction. In at least some embodiments, the visual representation is updated based on the user's interaction. In response to determining that there is user interaction with the visual representation, the operational flow returns to visual element display at S454. In response to determining that there is no user interaction with the visual representation, the operational flow ends.

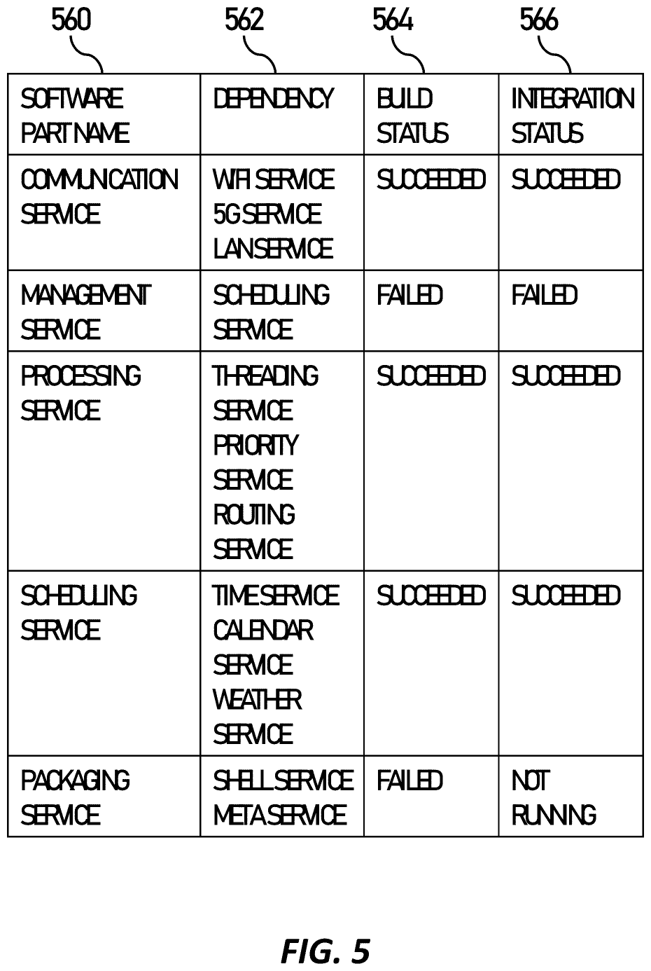

FIG. 5 is a visual representation in a table format, according to at least some embodiments of the subject disclosure. The visual representation includes a row or column for software part names 560, dependency 562, build status 564, and integration status 566.

In at least some embodiments, each software part is represented in a row or column in the visual representation. In at least some embodiments, the rows and columns are divided into fields. In at least some embodiments, these fields correspond to software part name, dependency, build status, and integration status of the software parts.

In at least some embodiments, the table format has a sorting function. In at least some embodiments, the table is sortable by dependency in response to user interaction. In at least some embodiments, the order of the rows or columns indicates the dependency between software parts. In at least some embodiments, the table view enables comparison and contrast of different software parts. In at least some embodiments, the table view enables sorting and filtering of data.

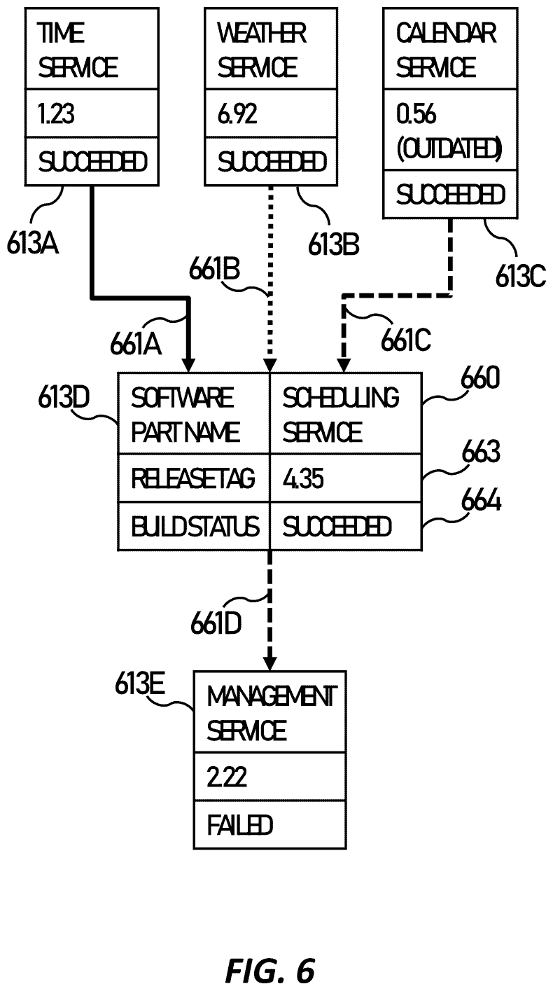

FIG. 6 is a visual representation in a node format, according to at least some embodiments of the subject disclosure. The visual representation includes representations of software parts of time service 613A, weather service 613B, calendar service 613C, scheduling service 613D, and management service 613E. The visual representation further includes connectors 661A, 661B, 661C, and 661D. The visual representation of scheduling service 613D includes software part name 660, release tag 663, and build status 664.

In at least some embodiments, the nodes in the visual representation format in node format represent the software parts. In at least some embodiments, each software part is represented as a distinct node. In at least some embodiments, connectors 661A, 661B, 661C, and 661D show dependencies between software parts. In at least some embodiments, an arrow of the connector is on the side of the dependent software part. In at least some embodiments, these connectors link the nodes. In at least some embodiments, connectors 661A, 661B, 661C, and 661D visually indicate the integration status between different software parts.

In at least some embodiments, the color or style of connectors 661A, 661B, 661C, and 661D is used to indicate the integration status. In at least some embodiments, the integration status is success, failure, or not running. In at least some embodiments, connectors 661A, 661B, 661C, and 661D provide immediate feedback on the integration status of the software parts.

In at least some embodiments, interaction with a software part switches the visual representation. In at least some embodiments, the node format shows a target software part, scheduling service 613D, and software parts directly related to the target software part. In at least some embodiments, each software part is represented as a node. In at least some embodiments, the node format provides a focused view of a specific software part and its immediate dependencies. In at least some embodiments, the representations of time service 613A, weather service 613B, calendar service 613C, and management service 613E includes a software part name, a release tag, and a build status. In at least some embodiments, a release tag, such as release tag 663, further indicates “OUTDATED” when the release is not the most recent, such as in calendar service 613C. For example, if an integration status between calendar service 613C and scheduling service 613D was generated when a release of calendar service 613C was not the most recent, then a release tag of calendar service 613C expressly indicates “OUTDATED”. In at least some embodiments, the most recent release tag information is displayed in response to interaction with the “OUTDATED” field of a software part in the visual representation.

In at least some embodiments, the color or style of the connectors changes to indicate the integration status. In at least some embodiments, the integration status is success, failure, or not running. In at least some embodiments, connector 661A indicates a successful integration. In at least some embodiments, connector 661B indicates a failed integration. In at least some embodiments, connectors 661C and 661D indicate not running. In at least some embodiments, the node view shows the direct impact of changes to a specific software part.

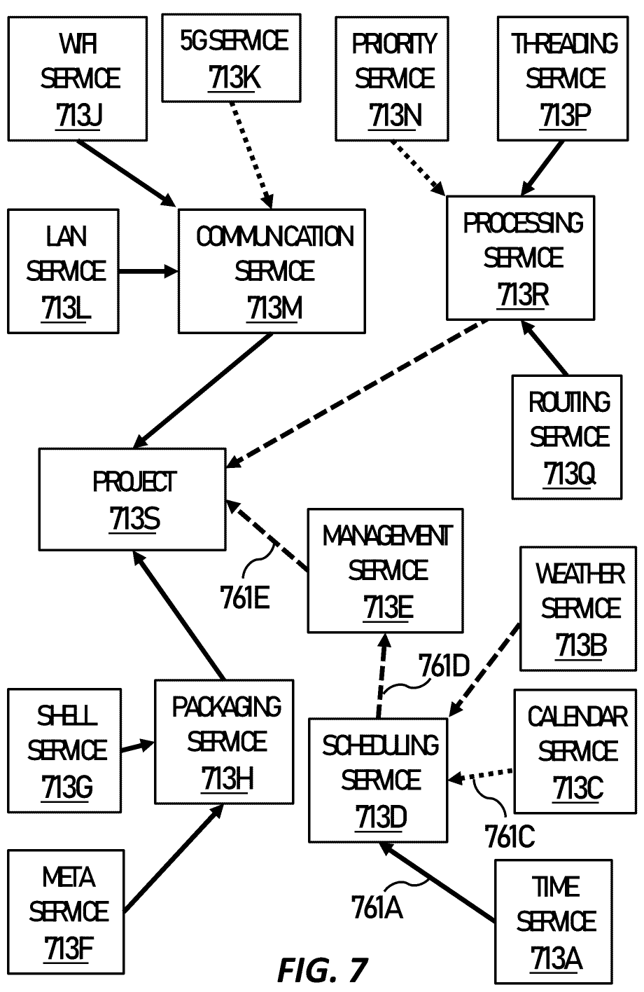

FIG. 7 is a visual representation in a network format, according to at least some embodiments of the subject disclosure. The visual representation includes representations of software parts of time service 713A, weather service 713B, calendar service 713C, scheduling service 713D, management service 713E, meta service 713F, shell service 713G, packaging service 713H, WiFi service 713EJ, 5G service 713K, LAN service 713L, communication service 713M, priority service 713N, threading service 713P, routing service 713Q, processing service 713R, and project 713S.

In at least some embodiments, the network format includes a node representing each software part. In at least some embodiments, nodes are interconnected by connectors, such as connectors 761A, 761C, 761D, and 761E. In at least some embodiments, the connectors signify dependencies between software parts in these embodiments. In at least some embodiments, an arrow of the connector is on the side of the dependent software part.

In at least some embodiments, the network format shows all software parts and their dependencies. In at least some embodiments, the network format incorporates interactive elements. In at least some embodiments, interaction with a software part alters the visual representation.

In at least some embodiments, the network format displays all software parts and their dependencies. In these embodiments, dependencies are indicated by connectors. In at least some embodiments, the color or style of connectors indicates a success status, a failure status, or a not running status. In at least some embodiments, the style of connector 761A indicates successful integration of time service 713A and scheduling service 713E. In at least some embodiments, the style of connector 761C indicates failed integration of calendar service 713C and scheduling service 713E. In at least some embodiments, the style of connector 761D indicates not running integration of scheduling service 713D and management service 713E. In at least some embodiments, the style of connector 761E indicates not running integration of management service 713E and project 713S.

FIG. 8 is a block diagram of a hardware configuration for software development visualization, according to at least some embodiments of the subject disclosure.

The exemplary hardware configuration includes server 800, which interacts with input device 807 directly or through network 809, and communicates with repository 820, database 822, and client device 824 through network 809. In at least some embodiments, input device 807 is a touch screen, a microphone, a camera, or any other device configured to detect tactile, aural, visual, etc. input. In at least some embodiments, network 809 is an ethernet network, a Controller Arca Network (CAN), or any other wired or wireless network or a combination thereof. In at least some embodiments, server 800 is a computer or other computing device that receives input or commands from input device 807. In at least some embodiments, server 800 is integrated with input device 807. In at least some embodiments, server 800 is a computer system that executes computer-readable instructions to perform operations for software development visualization.

Server 800 includes a controller 802, a storage 804, an input/output interface 806, and a communication interface 808. In at least some embodiments, controller 802 includes a processor or programmable circuitry executing instructions to cause the processor or programmable circuitry to perform operations according to the instructions. In at least some embodiments, controller 802 includes analog or digital programmable circuitry, or any combination thereof. In at least some embodiments, controller 802 includes physically separated storage or circuitry that interacts through communication. In at least some embodiments, storage 804 includes a non-volatile computer-readable medium capable of storing executable and non-executable data for access by controller 802 during execution of the instructions. In at least some embodiments, communication interface 808 transmits and receives data from network 809. In at least some embodiments, input/output interface 806 connects to various input and output units, such as input device 807, via a parallel port, a serial port, a keyboard port, a mouse port, a monitor port, and the like to accept commands and present information. In some embodiments, storage 804 is external from server 800.

Controller 802 includes building section 870, reading section 872, generating section 874, and transmitting section 876. storage 804 includes build parameters 880, test parameters 882, configuration files 884, and script 886.

Building section 870 is the circuitry or instructions of controller 802 configured to build software parts. In at least some embodiments, building section 870 is configured to assign standby status to an application in response to determining that the application does not have priority. In at least some embodiments, building section 870 utilizes information in storage 804, such as build parameters 880, test parameters 882, and configuration files 884. In at least some embodiments, building section 870 includes sub-sections for performing additional functions, as described in the foregoing flow charts. In at least some embodiments, such sub-sections are referred to by a name associated with a corresponding function.

Reading section 872 is the circuitry or instructions of controller 802 configured to read configuration files. In at least some embodiments, reading section 872 is configured to record any display output and audio output generated by the application. In at least some embodiments, reading section 872 utilizes information in storage 804, such as configuration files 884. In at least some embodiments, reading section 872 includes sub-sections for performing additional functions, as described in the foregoing flow charts. In at least some embodiments, such sub-sections are referred to by a name associated with a corresponding function.

Generating section 874 is the circuitry or instructions of controller 802 configured to generate records. In at least some embodiments, generating section 874 is configured to modify, in response to a request from the application, the recording of output generated by the application. In at least some embodiments, reading section 872 utilizes information in storage 804, such as configuration files 884. In at least some embodiments, generating section 874 includes sub-sections for performing additional functions, as described in the foregoing flow charts. In at least some embodiments, such sub-sections are referred to by a name associated with a corresponding function.

Transmitting section 876 is the circuitry or instructions of controller 802 configured to transmit records. In at least some embodiments, transmitting section 876 is configured to replay any content of the recording in response to determining that the application has priority. In at least some embodiments, transmitting section 876 utilizes information in storage 804, such as script 886. In at least some embodiments, transmitting section 876 includes sub-sections for performing additional functions, as described in the foregoing flow charts. In at least some embodiments, such sub-sections are referred to by a name associated with a corresponding function.

In at least some embodiments, the apparatus is another device capable of processing logical functions in order to perform the operations herein. In at least some embodiments, the controller and the storage unit need not be entirely separate devices, but share circuitry or one or more computer-readable mediums in some embodiments. In at least some embodiments, the storage unit includes a hard drive storing both the computer-executable instructions and the data accessed by the controller, and the controller includes a combination of a central processing unit (CPU) and RAM, in which the computer-executable instructions are able to be copied in whole or in part for execution by the CPU during performance of the operations herein.

In at least some embodiments where the apparatus is a computer, a program that is installed in the computer is capable of causing the computer to function as or perform operations associated with apparatuses of the embodiments described herein. In at least some embodiments, such a program is executable by a processor to cause the computer to perform certain operations associated with some or all of the blocks of flowcharts and block diagrams described herein.

At least some embodiments are described with reference to flowcharts and block diagrams whose blocks represent (1) steps of processes in which operations are performed or (2) sections of a controller responsible for performing operations. In at least some embodiments, certain steps and sections are implemented by dedicated circuitry, programmable circuitry supplied with computer-readable instructions stored on computer-readable media, and/or processors supplied with computer-readable instructions stored on computer-readable media. In at least some embodiments, dedicated circuitry includes digital and/or analog hardware circuits and include integrated circuits (IC) and/or discrete circuits. In at least some embodiments, programmable circuitry includes reconfigurable hardware circuits comprising logical AND, OR, XOR, NAND, NOR, and other logical operations, flip-flops, registers, memory elements, etc., such as field-programmable gate arrays (FPGA), programmable logic arrays (PLA), etc.

In at least some embodiments, the computer readable storage medium includes a tangible device that is able to retain and store instructions for use by an instruction execution device. In some embodiments, the computer readable storage medium includes, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

In at least some embodiments, computer readable program instructions described herein are downloadable to respective computing/processing devices from a computer readable storage medium or to an external computer or external storage device via a network, for example, the Internet, a local area network, a wide area network and/or a wireless network. In at least some embodiments, the network includes copper transmission cables, optical transmission fibers, wireless transmission, routers, firewalls, switches, gateway computers and/or edge servers. In at least some embodiments, a network adapter card or network interface in each computing/processing device receives computer readable program instructions from the network and forwards the computer readable program instructions for storage in a computer readable storage medium within the respective computing/processing device.

In at least some embodiments, computer readable program instructions for carrying out operations described above are assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. In at least some embodiments, the computer readable program instructions are executed entirely on the user's computer, partly on the user's computer, as a stand-alone software package, partly on the user's computer and partly on a remote computer or entirely on the remote computer or server. In at least some embodiments, in the latter scenario, the remote computer is connected to the user's computer through any type of network, including a local area network (LAN) or a wide area network (WAN), or the connection is made to an external computer (for example, through the Internet using an Internet Service Provider). In at least some embodiments, electronic circuitry including, for example, programmable logic circuitry, field-programmable gate arrays (FPGA), or programmable logic arrays (PLA) execute the computer readable program instructions by utilizing state information of the computer readable program instructions to individualize the electronic circuitry, in order to perform aspects of the present invention.

While embodiments of the present invention have been described, the technical scope of any subject matter claimed is not limited to the above-described embodiments. Persons skilled in the art would understand that various alterations and improvements to the above-described embodiments are possible. Persons skilled in the art would also understand from the scope of the claims that the embodiments added with such alterations or improvements are included in the technical scope of the invention.

The operations, procedures, steps, and stages of each process performed by an apparatus, system, program, and method shown in the claims, embodiments, or diagrams are able to be performed in any order as long as the order is not indicated by “prior to,” “before,” or the like and as long as the output from a previous process is not used in a later process. Even if the process flow is described using phrases such as “first” or “next” in the claims, embodiments, or diagrams, such a description does not necessarily mean that the processes must be performed in the described order.

In at least some embodiments, software development visualization is performed by reading a configuration file of a plurality of software parts in response to building the plurality of software parts, the plurality of software parts including a first software part and a second software part, the second software part depending upon the first software part, and generating a record of the plurality of software parts, the record including dependency between the first software part and the second software part, a build status of the plurality of software parts, and an integration status between the first software part and the second software part.

In at least some embodiments, the integration status includes one of success status and failure status. In at least some embodiments, the integration status includes one of success status, failure status, and not running status. In at least some embodiments, software development visualization further includes building the plurality of software parts. In at least some embodiments, the build status indicates a newest release tag in response to successfully building the plurality of software parts. In at least some embodiments, the build status indicates a previous release tag in response to not successfully building the plurality of software parts. In at least some embodiments, software development visualization further includes receiving an instruction to build the plurality of software parts. In at least some embodiments, software development visualization further includes determining a test indicated in the configuration file. In at least some embodiments, software development visualization further includes performing the test in response to building the software part to produce a test result, the test result indicating the integration status. In at least some embodiments, software development visualization further includes building the plurality of software parts. In at least some embodiments, the configuration file indicates a version of each input software part used during the building. In at least some embodiments, the record further indicates a time of building the plurality of software parts. In at least some embodiments, software development visualization further includes providing, to a client device, a script including instructions for displaying a visual representation of interdependency among the plurality of software parts. In at least some embodiments, the visual representation includes a connector joining the software part and the second software part. In at least some embodiments, software development visualization further includes the connector visually indicates the integration status. In at least some embodiments, visual representation includes the build status of the second software part. In at least some embodiments, software development visualization further includes the visual representation includes each software part in a row or column of a table having fields corresponding to the dependency, build status, and integration status. In at least some embodiments, software development visualization further includes transmitting the record to a database, and transmitting, in response to a request from a client device, the record from the database. In at least some embodiments, the visual representation includes a release tag, the release tag indicating whether the release is outdated. In at least some embodiments, software development visualization further includes the script includes instructions for switching a visual representation in response to interaction with the first software part. In at least some embodiments, software development visualization further includes the script includes instructions for sorting software parts of the table by dependency.

In at least some embodiments, software development visualization is performed by a processor executing instructions in accordance with the foregoing operations or a device comprising a controller including circuitry configured to perform the foregoing operations.

The foregoing outlines features of several embodiments so that those skilled in the art would better understand the aspects of the present disclosure. Those skilled in the art should appreciate that this disclosure is readily usable as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that various changes, substitutions, and alterations herein are possible without departing from the spirit and scope of the present disclosure.

What is claimed is:

1. A non-transitory computer-readable medium having instructions recorded thereon that, in response to execution by one or more processors, cause performance of operations comprising:
reading a configuration file of a plurality of software parts in response to building the plurality of software parts, the plurality of software parts including a first software part and a second software part, the second software part depending upon the first software part; and
generating a record of the plurality of software parts, the record including
dependency between the first software part and the second software part,
a build status of the plurality of software parts, and
an integration status between the first software part and the second software part.

2. The computer-readable medium of claim 1, wherein the integration status includes one of success status and failure status.

3. The computer-readable medium of claim 1, wherein the integration status includes one of success status, failure status, and not running status.

4. The computer-readable medium of claim 1, wherein the operations further comprise building the plurality of software parts;
wherein the build status indicates a newest release tag in response to successfully building the plurality of software parts; and
wherein the build status indicates a previous release tag in response to not successfully building the plurality of software parts.

5. The computer-readable medium of claim 1, wherein the operations further comprise receiving an instruction to build the plurality of software parts;
determining a test indicated in the configuration file; and
performing the test in response to building the software part to produce a test result, the test result indicating the integration status.

6. The computer-readable medium of claim 1, wherein the operations further comprise building the plurality of software parts;
wherein the configuration file indicates a version of each input software part used during the building.

7. The computer-readable medium of claim 1, wherein the record further indicates a time of building the plurality of software parts.

8. The computer-readable medium of claim 1, wherein the operations further comprise
providing, to a client device, a script including instructions for displaying a visual representation of interdependency among the plurality of software parts.

9. The computer-readable medium of claim 8, wherein the visual representation includes a connector joining the software part and the second software part.

10. The computer-readable medium of claim 9, wherein the connector visually indicates the integration status.

11. The computer-readable medium of claim 9, wherein the visual representation includes the build status of the second software part.

12. The computer-readable medium of claim 9, wherein the visual representation includes each software part in a row or column of a table having fields corresponding to the dependency, build status, and integration status.

13. The computer-readable medium of claim 9, wherein the operations further comprise
transmitting the record to a database; and
transmitting, in response to a request from a client device, the record from the database.

14. The computer-readable medium of claim 9, wherein the visual representation includes a release tag, the release tag indicating whether the release is outdated.

15. The computer-readable medium of claim 8, wherein the script includes instructions for switching a visual representation in response to interaction with the first software part.

16. The computer-readable medium of claim 8, wherein the script includes instructions for sorting software parts of the table by dependency.

17. A method comprising:
reading a configuration file of a plurality of software parts in response to building the plurality of software parts, the plurality of software parts including a first software part and a second software part, the second software part depending upon the first software part; and
generating a record of the plurality of software parts, the record including
dependency between the first software part and the second software part,
a build status of the plurality of software parts, and
an integration status between the first software part and the second software part.

18. The method of claim 17, wherein the integration status includes one of success status and failure status.

19. The method of claim 17, wherein the integration status includes one of success status, failure status, and not running status.

20. A device comprising:
a controller including circuitry configured to perform operations including
reading a configuration file of a plurality of software parts in response to building the plurality of software parts, the plurality of software parts including a first software part and a second software part, the second software part depending upon the first software part, and
generating a record of the plurality of software parts, the record including dependency between the first software part and the second software part,
a build status of the plurality of software parts, and
an integration status between the first software part and the second software part.
